(19) United States
(12) Patent Application Publication
(10) Pub. No.: US 2014/0160150 A1
(43) Pub. Date: Jun. 12, 2014

(54) REMOTE COLLABORATIVE DIAGNOSIS METHOD AND SYSTEM USING SERVER-BASED MEDICAL IMAGE SHARING SCHEME

(71) Applicant: Infinitt Healthcare Co., Ltd., (unknown)

(72) Inventors: Hyung Tae JOO, Seoul (KR); Kyo Bum KU, Seoul (KR)

(73) Assignee: Infinitt Healthcare Co., Ltd.

(21) Appl. No.: 14/102,971

(22) Filed: Dec. 11, 2013

(30) Foreign Application Priority Data
Dec. 12, 2012 (KR) 10-2012-0144293

(51) Int. Cl. G06T 7/00

(52) U.S. Cl. CPC G06T 7/0012
USPC 345/619

(57) ABSTRACT

Disclosed are a server-based medical image sharing method and system. The system provides a first medical image requested by a first viewer to the first viewer and receives information about a second user with whom the first medical image will be shared by the first viewer; The system provides the first medical image to a second viewer based on the information about the second user; When a user input related to an operation of the first medical image is received from any one of the first and second viewers, the system processes the first medical image, and generate a second medical image related to the first medical image. The system provides the generated second medical image to the first and second viewers.

### CROSS-REFERENCE TO RELATED APPLICATION

This application claims under 35 U.S.C. §119(a) the benefit of Korean Application No. 10-2012-0144293 filed Dec. 12, 2012, which application is incorporated herein by reference.

### TECHNICAL FIELD

The present invention relates, in general, to remote collaborative diagnosis based on medical image sharing and, more particularly, to a remote collaborative diagnosis method and system using a server-based medical image sharing scheme, which are capable of sharing medical images for remote collaborative diagnoses using information about links to the medical images via a server that provides medical images.

### BACKGROUND ART

Most people visit hospitals because of various types of serious or minor diseases or for other reasons. Although an overall process can be smoothly performed in a hospital and the process can be dealt with based on the opinions of a small number of medical experts, cases where a plurality of medical experts should gather and exchange their opinions frequently occur.

In this case, individual medical experts work in their respective fields on their respective schedules, and thus it is very difficult for all required personnel to gather and exchange opinions in a single place at the same time.

Furthermore, all medical personnel working at actual medical sites may recognize that when opinions are exchanged via documents, problems with communication may occur in the exchange of opinions based only on documents and also it take a long time to transfer opinions.

Accordingly, a need arises to enable remote collaborative diagnoses to be easily made. As a technology capable of supporting such remote collaborative diagnoses, Korean Patent No. 10-1039001 discloses “Collaborative Diagnosis System and Method.” This patent proposes a remote collaborative diagnosis system that is capable of exchanging information via a video conference on a preset schedule.

However, the remote collaborative diagnosis system based on a video conference has no provision for the processing of various data, information and/or images. Thanks to the recent development of medical imaging technology, the diagnoses of patients are frequently made based on various medical images. As a result, in order to make more improved remote collaborative diagnoses, a user interface capable of supporting the function of adjusting, editing and processing of medical images as well as the function of simply displaying medical images is demanded.

### SUMMARY OF THE DISCLOSURE

Accordingly, the present invention has been made keeping in mind the above problems occurring in the prior art, and an object of the present invention is to provide a remote collaborative diagnosis method and system using a server-based medical image sharing scheme, which are capable of sharing medical images using information about links to the medical images via a server for providing medical images, thereby facilitating remote collaborative diagnoses.

Still another object of the present invention is to provide a user interface that enables a plurality of users participating in a collaborative diagnosis in a remote environment to conveniently share the operation, such as expansion, reduction and the changing of direction, of a medical image displayed to the users in common, annotation, the selection of a medical image of interest from a set of various medical images, switching between a plurality of medical images displayed at the same time, 3-dimensional (3D) rendering, the results of additional processing, such as a computer aided diagnosis (CAD), and/or the like.

Still another object of the present invention is to provide a remote collaborative diagnosis method and system using a server-based medical image sharing scheme, which are capable of reducing data traffic between viewers and improving the security of medical images.

More specifically, this object of the present invention is to provide a remote collaborative diagnosis method and system using a server-based medical image sharing scheme, which transmit only information about links to medical images to be shared to the viewers of users who make collaborative diagnoses via messengers, and receive the sharing-target (in other words, target-to-share) medical images corresponding to the information about links from a medical image sharing server for providing medical images, thereby reducing traffic between viewers, and improving the security of medical images and protecting private information because medical images, annotation, text and voice information, CAD results, etc. are shared by the medical image sharing server.

In accordance with an aspect of the present invention, there is provided a server-based medical image sharing method, including providing, by a processor, a first viewer with a first medical image requested by a first user of the first viewer; receiving, at the processor, information about a second user for sharing the first medical image with the first viewer; providing, by the processor, a second viewer of the second user with the first medical image based on the information about the second user; receiving, at the processor, a user input related to an operation of the first medical image from any one of the first and second viewers; processing, by the processor, the first medical image based on the received user input, and generating a second medical image related to the first medical image; and providing, by the processor, the first and second viewers with the generated second medical image.

Receiving information about the second user may include, if the first and second viewers have been synchronized with each other, receiving the information about the second user from any one of the first and second viewers. The first and second viewers may be synchronized via messengers provided in the first and second viewers, respectively.

The server-based medical image sharing method may further include receiving information about sharing (medical image sharing), wherein the information about sharing may be set by the first user, which belongs to information related to the first medical image, from the first viewer; providing the first medical image may include providing the first medical image and the set information about sharing to the second viewer.

The server-based medical image sharing method may further include, if at least one of an annotation, text, and voice information is received from any one of the first and second viewers, providing the received information to the other viewer so that the received information can be shared with the other viewer.

Providing the first medical image may include searching for information about a user group requested by the first user from information about one or more user groups, and providing the retrieved information about the user group to the first viewer; and receiving the information about the second user may include receiving information about the second user selected by the first user from among a plurality of users included in the retrieved information about the user group.

Providing the first medical image may include searching for a plurality of users with whom the first medical image will be shared based on user information previously stored by the first user, and providing the plurality of retrieved users to the first viewer along with the first medical image; and receiving the information about the second user may include receiving information about the second user selected by the first user from among the plurality of users.

Providing the first medical image may include providing information about a link to the first medical image to the second viewer, and providing the first medical image to the second viewer.

In accordance with another aspect of the present invention, there is provided a server-based medical image sharing system, including a sending unit configured to provide a first medical image requested by a first user of a first viewer to the first viewer; a reception unit configured to receive information about a second user with whom the first medical image will be shared by the first viewer; a sharing control unit configured to control the sending unit to provide the first medical image to a second viewer of the second user based on the information about the second user; and an image processing unit configured to, when a user input related to an operation of the first medical image is received from any one of the first and second viewers, process the first medical image based on the received user input, and generate a second medical image related to the first medical image; wherein the sharing control unit controls the sending unit to provide the generated second medical image to the first and second viewers.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a server-based medical image sharing system according to an embodiment of the present invention;

FIG. 2 is a diagram illustrating the configuration of the medical image sharing server illustrated in FIG. 1 according to an embodiment of the present invention;

FIG. 3 is a diagram illustrating an example of controlling the medical image shared between the two viewers of FIG. 1;

FIG. 4 is a diagram illustrating another example of controlling the medical image shared between the two viewers of FIG. 1;

FIG. 5 is a flowchart illustrating the process of a server-based medical image sharing method according to an embodiment of the present invention;

FIG. 6 is a flowchart illustrating the detailed process of step S520 illustrated in FIG. 5 according to an embodiment of the present invention; and

FIG. 7 is a flowchart illustrating the detailed process of step S520 illustrated in FIG. 5 according to another embodiment of the present invention.

### DETAILED DESCRIPTION OF THE DISCLOSURE

Hereinafter, embodiments of the present invention will be described in detail with reference to the accompanying drawings. Reference now should be made to the elements of drawings, in which the same reference numerals are used throughout the different drawings to designate the same elements. In the following description, detailed descriptions of known elements or functions that may unnecessarily make the gist of the present invention obscure will be omitted.

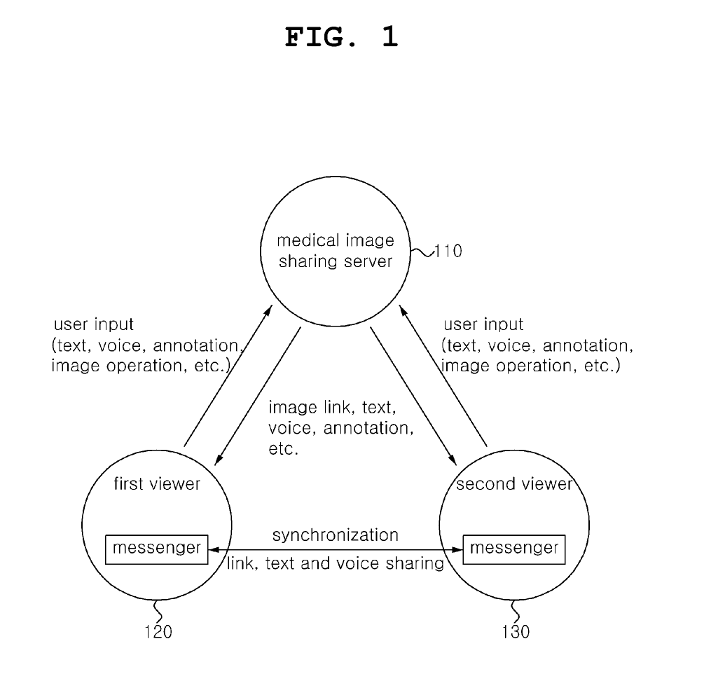

A remote collaborative diagnosis method and system using a server-based medical image sharing scheme according to an embodiment of the present invention will be described in detail below with reference to FIGS. 1 to 7.

FIG. 1 is a diagram illustrating the configuration of a server-based medical image sharing system according to an embodiment of the present invention.

Referring to FIG. 1, the system according to the present invention includes a medical image sharing server 110, a first viewer 120, and a second viewer 130. In the following detailed description of the present invention, for ease of description, the first viewer 120 is assumed to be the viewer of a user who requests medical image sharing (hereinafter referred to as the “first user”), and the second viewer 130 is assumed to be the viewer of a user who is selected by the user of the first viewer 120 (hereinafter referred to as the “second user”).

The first viewer 120 includes a messenger to communicate with the messenger of the second viewer 130 in order to make a collaborative diagnosis. The first viewer 120 requests and receives a medical image from the medical image sharing server 110, displays the medical image on a screen, selects a second user with whom the medical image will be shared when the medical image is to be shared in response to a request from the first user, and provides information about a link to the medical image to be shared to the messenger of the second viewer 130 via its own messenger.

In this case, the first user of the first viewer 120 may receive information about a plurality of users from the medical image sharing server 110 and then select the second user based on the received information about a plurality of users. Alternatively, the first user of the first viewer 120 may select the second user from among the users of other messengers connected to its own messenger.

Furthermore, the first user may acquire information about a user group preset by the first user and then select the second user from among users included in the acquired information about the user group. In this case, the information about the user group may be stored in the first viewer 120, or may be stored in the medical image sharing server 110 and provided to the first viewer 120 in response to a request from the first user.

In this case, the first user may add, delete and change users included in the information about the user group using an interface provided in the first viewer 120 or messenger. The information about the user group set by the first user information about a basic group to which the first user belongs to, or information about a first group related to another department to which the first user does not belong. It will be apparent that the first user may select one of the information about a basic group and the information about a first group using the interface provided in the first viewer or messenger.

In this case, the first viewer 120 may perform a synchronization process required to share the medical image with the second viewer 130. Once the first viewer 120 has been synchronized with the second viewer 130, the first viewer 120 may provide the information about the link to the medical image to be shared (hereinafter referred to as the “sharing-target medical image”) to the messenger of the second viewer 130, and may later share a sharing-target medical image in which a user operation input by the first or second user has been processed, text, voice, etc. via the medical image sharing server 110. It will be apparent that in some cases, information about links to a user operation, text, voice, etc. may be transmitted and received via the messengers and thus a sharing-target medical image in which a user operation input by the first or second user has been processed, text, voice, etc. may be shared.

In this case, the synchronization between the first and second viewers 120 and 130 may be synchronization between the messenger of the first viewer 120 and the messenger of the second viewer 130, or may be synchronization achieved via the medical image sharing server 110.

In the present invention, the first and second viewers 120 and 130 are described as receiving processing results attributable to the input of the first or second user, for example, a sharing-target medical image in which rotation, expansion, reduction or rendering has been processed in response to the image operation of a user, CAD results, an annotation, text, voice or the like, directly from the medical image sharing server 110.

It will be apparent that the first and second viewers 120 and 130 do not necessarily receive processing results attributable to user input directly from the medical image sharing server 110, but may receive information about a link to processing results from the medical image sharing server 110 and then receive the processed results via the information about a link.

When a user operation, an annotation, text, voice or like is input after the first viewer 120 has been synchronized with the second viewer 130, the first viewer 120 may provide the input information to the medical image sharing server 110, the medical image sharing server 110 provides information about a related link to the two viewers, and thus the two viewers may share results attributable to the user input of any one viewer, thereby minimizing traffic between the two viewers.

It will be apparent that information about a link to results attributable to user input may be transmitted and received between the two viewers via the messengers. In this case, a viewer via which user input has been performed may receive information about a link to results attributable to the user input from the medical image sharing server 110, and may provide the information about a link to the other viewer.

That is, although the information about a link used in the detailed description of the invention may be generated by a viewer and transferred to the other viewer via the messengers, it may be generated by the medical image sharing server 110 and provided to individual viewers. Alternatively, any one viewer may receive information about a link generated by the medical image sharing server 110, and may provide it to the other viewer.

In this case, it will be apparent that in order to directly provide information about a link from the medical image sharing server 110 to the second viewer 130, the medical image sharing server 110 should acquire information about the second user of the second viewer in advance. This will be described in detail when the medical image sharing server 110 is described later.

The messenger provided in each viewer is a real-time remote collaborative diagnosis-enabled messenger. The messenger may a messenger specialized for the medical image sharing server 140, for example, a Picture Archival and Communication System (PACS), and may includes an interface constructed to share medical images.

In this case, the first user may set information about the sharing of a sharing-target medical image using a user interface provided in the messenger of the first viewer 120. The set information about the sharing may include the range of the sharing of sharing-target medical image-related information, a sharing-target medical image control method, operation control authority, etc. In this case, the sharing-target medical image-related information may include information about whether the second user can adjust and/or edit the sharing-target medical image, the ranges of adjustment and/or editing, whether CAD results, annotations, windowing, rendering, etc. are shared. Furthermore, the operation control authorities may include not only the authority to perform user input related to a sharing-target medical image but also the authority to perform annotation, windowing, and rendering. That is, the first user may set the range of information sharing related to a sharing-target medical image, access authority, operation control, etc. when a collaborative diagnosis is made.

The set information about the sharing of the sharing-target medical image may be transmitted to the medical image sharing server 110 using the user interface. The medical image sharing server 110 may transmit data to the second viewer while taking into consideration the information about the sharing.

The second viewer 130 is the viewer of the second user that communicates with the first viewer 120 in order to make a collaborative diagnosis. The second viewer 130 is requested to perform a collaborative diagnosis by the first viewer 120 via the messenger of the first viewer 120 and the messenger of the second viewer 130, accepts the request via the approval of the second user, performs a synchronization process, and then receives information about a link to a sharing-target medical image from the medial image sharing server 110, thereby receiving the sharing-target medical image corresponding to the information about a link from the medical image sharing server 110 and then displaying the sharing-target medical image on a screen.

The first viewer 120 may exchange information about links to a sharing-target medical image, an annotation, text, voice, etc. with the second viewer 130 via the messengers or medical image sharing server 110. The first and second viewers 120 and 130 may share the sharing-target medical image, the annotation, the text, the voice, etc. via the medical image sharing server 110 based on the exchanged information about links.

It will be apparent that in the case of the second viewer 130, information to be shared and user input may be limited based on the information about the sharing of the sharing-target medical image set by the first user.

The medical image sharing server 110 is a server that enables the sharing of a medical image and medical image-related information so that the first and second viewers 120 and 130 can make a collaborative diagnosis. The medical image sharing server 110 provides the sharing-target medical image requested by the first user of the first viewer 120 to the first viewer 120, receives information about the second user of the second viewer 130, provides the sharing-target medical image (hereinafter referred to as the “first sharing-target medical image”) to the second viewer 130, processes the first sharing-target medical image based on a user input entered by any one of the two viewers, generates a sharing-target medical image related to the results of processing of the first sharing-target medical image (hereinafter referred to as the “second sharing-target medical image”), and provides the second sharing-target medical image to the first and second viewers 120 and 130.

In this case, the processing of the first sharing-target medical image may include an operation, such as rotation, expansion, or reduction, may include an operation of overlaying an annotation on a screen, and may include CAD results or rendering.

The medical image sharing server 110 may receive the information about the second user from any one of the first and second viewers 120 and 130. The time at which the information about the second user is received is the time at which the first and second viewers 120 and 130 are synchronized if synchronization is achieved via the messengers of the two viewers. The time at which the information about the second user is received is the time at which the first user of the first viewer selects the second user if synchronization is achieved via the medical image sharing server 110.

The medical image sharing server 110 may search for a medical image requested by each of the viewers and then provide the medical image.

In the present invention, the medical image sharing server 110 may provide at least one medical image to two or more viewers to enable a collaborative diagnosis to be made, and may also provide at least one medical image generated through the processing of user input to the viewers. Furthermore, the medical image sharing server 110 may search for related users and provide information about the retrieved users to the first viewer 120 so that the first viewer 120 can easily select the second user.

As an example, the medical image sharing server 110 may search for a plurality of users corresponding to the characteristic information of the first sharing-target medical image from among previously stored users based on the characteristic information of the first sharing-target medical image requested by the first viewer 120, and may provide information about the plurality of retrieved users to the first viewer 120, thereby allowing the first user to select the second user along with whom a collaborative diagnosis will be made.

In this case, the characteristic information of a medical image may include the type of medical imaging apparatus that has captured the medical image, for example, a computerized tomography (CT) scanner, a magnetic resonance imaging (MRI) scanner, a positron emission tomography (PET) scanner or an X-ray machine, a captured bodily region, a region of interest in the medical image, a field related to the sharing-target medical image, etc.

As another example, the medical image sharing server 110 may search for a plurality of users corresponding to information about the first user from among previously stored users based on the information about the first user, and may provide the plurality of retrieved users to the first viewer 120, thereby enabling the first user to select the second user along with whom a collaborative diagnosis will be made.

In this case, the information about the first user may include the department, professional field (for example, specialized cancer treatment) and/or the like of the first user, and may also include all user information that can be applied in connection with a collaborative diagnosis.

If needed, the medical image sharing server 110 may search for a plurality of users from among previously stored users while taking into consideration the characteristic information of the first sharing-target medical image and information about the first user.

As a still another example, the medical image sharing server 110 may store information about a plurality of groups including a plurality of users, and may provide information about a corresponding group requested by the first user to the first viewer, thereby enabling the first user to select the second user from among users included in the information about a corresponding group.

In this case, the information about a user group may be classified according to its professional field (a medical department), in which case the information about a user group includes users in a corresponding field. Furthermore, the information about a user group may include information about a basic group set by the first user. The users included in the information about a basic group may be added, modified and/or deleted by the first user.

Furthermore, the medical image sharing server 110 may receive the information about sharing set by the first user from the first viewer 120, may store the received information about sharing together with the sharing-target medical image, and may provide both the information about sharing and the sharing-target medical image to the second viewer 130.

Furthermore, when at least one of annotation, text and voice information is received from any one of the two viewers, the medical image sharing server 110 may provide the received information to the other viewer, thereby enabling the two viewers to share the corresponding information.

In this case, although the medical image sharing server 110 may provide the corresponding information directly to the two viewers, the medical image sharing server 110 may provide information about a link to the corresponding information, thereby allowing the corresponding information to be provided to the two viewers via information about the link.

Moreover, the medical image sharing server 110 may store image and text result data attributable to a collaborative diagnosis, for example, a sharing-target medical image manipulated by user input, and/or an annotation, windowing and/or rendering input by the first or second user. This collaborative diagnosis result data may be stored in a database table that has been mapped to the corresponding image data. The medical image sharing server 110 may provide the collaborative diagnosis result data stored in the database table for reference when the corresponding image data is read in the future. It will be apparent that the collaborative diagnosis result data stored in the medical image sharing server 110 may be stored in response to a request from the first or second user who makes a collaborative diagnosis. Although it is preferable to store the collaborative diagnosis result data in response to a request from the first user who has requested a collaborative diagnosis, the present invention is not limited thereto. If the second user has the authority related to storage, the collaborative diagnosis result data may be stored in response to a request from the second user. The collaborative diagnosis result data stored in the medical image sharing server 110 may be updated by the first and second users who make the collaborative diagnosis. It is preferred that the collaborative diagnosis result data be updated by the first user who has requested the collaborative diagnosis.

As described above, the server-based medical image sharing system according to the present invention enables a medical image to be shared between the viewers via the medical image sharing server in order to enable a collaborative diagnosis, thereby reducing traffic between the messengers, that is, between the viewers, improving the security of the medical image and the protection of private information, and also reducing the traffic of the medical image sharing server because a collaborative diagnosis is made via the messengers.

Although FIG. 1 illustrates that the first user of the first viewer requests a collaborative diagnosis, the second user of the second viewer accepts the request and thus a medical image is shared, the present invention is not limited thereto, and vice versa. Furthermore, after the first viewer and the second viewer have been synchronized with each other, a new medical image may be shared via the medical image sharing server in response to a request form the first or second user.

In FIG. 1, the embodiment in which the screen of the results of operations, for example, rotation, performed on an image being shared between users participating in a remote collaborative diagnosis is shared has been illustrated. However, it will be apparent that the spirit of the present invention is not limited to this embodiment. In another embodiment of the present invention, the results of operations, for example, expansion, reduction, the changing of direction (the changing of a view point), and rotation, performed on an image being shared between users participating in a remote collaborative diagnosis may be synchronized and shared. Furthermore, the annotation information of any one user related to a shared image may be displayed to other users in a synchronized state. When any one user has selected a medical image of interest from a set of various medical images, the results of the selection may be provided to other users. When a plurality of medical images is displayed, the results of switching between screens performed by any one user may be also provided to other users.

Meanwhile, an operation, such as the rotation, expansion or reduction of an image, performed in response to a request from a user, may be performed on 3D medical images obtained by 3D rendering, and may also be performed on two-dimensional (2D) medical images, such as CT and MRI tomographic slice images, sagittal, coronal and axial images, multi-planar reformatting (MPR) images, etc.

Furthermore, the results of additional processing performed in response to a request from any one user may be shared with other users. Examples of additional processing include 3D rendering, segmentation related to a Region of Interest (ROI), such as a tumor, and CAD results.

An operation, the display of an annotation, the selection of an image, the switching between screens, additional processing, and/or the like may be executed by the medical image sharing server 110 in response to a request from any one user. The results of the execution may be shared among the viewers of a plurality of users.

In this case, when an operation, the addition of an annotation, the selection of an image, a request for the switching between screens, or a request for additional processing is input by any one user via a user interface, the system according to the present invention may additionally provide a confirmation menu that is used to check whether to share the processing results of the request with other users. The confirmation menu may be selectively provided by taking into consideration factors, such as the processing cost of a user request, resources for the processing of the user request, and/or the processing time of the user request. That is, the confirmation menu that is used to check whether to share the processing results of the request with other users is provided if the user request occupies many resources or requires a long processing time, and the processing results of the request may be shared with other users without providing the confirmation menu if the user request can be immediately processed.

In contrast, the confirmation menu that is used to check whether to share the processing results of a user request with other users may be provided depending on whether a user request is closely related to the private information of a patient, rather than depending on the processing cost, resources and processing time of the user request. In this case, even for the same screen operation, whether to provide the confirmation menu may be determined depending on the type of lesion or organ that is related to a user request.

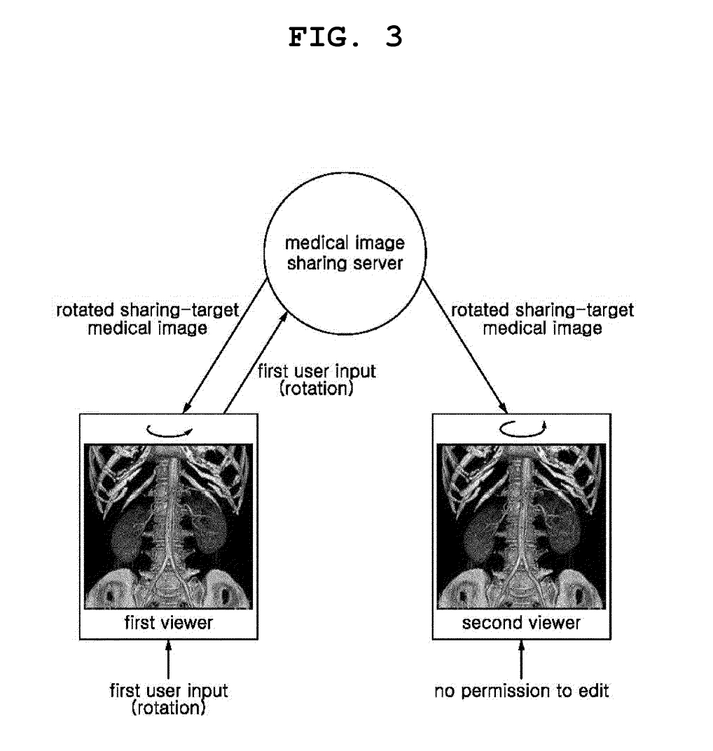

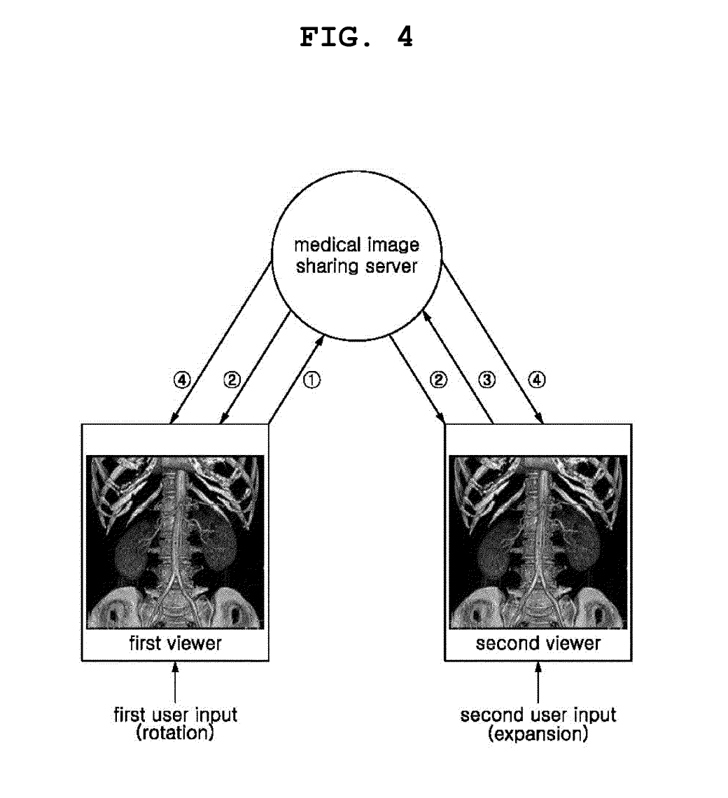

The operations between the first viewer 120, the second viewer 130 and the medical image sharing server 110 that constitute the system of the present invention will be described in greater detail with reference to FIGS. 3 and 4.

FIGS. 3 and 4 are diagrams illustrating examples of controlling a medical image shared between two viewers. FIG. 3 illustrates an example in which a sharing-target medical image cannot be adjusted and edited via the second viewer. FIG. 4 illustrates an example in which a sharing-target medical image can be freely adjusted and edited via the first and second viewers.

In this case, information about whether or not a sharing-target medical image can be manipulated via the second viewer may be set by the first user of the first viewer.

(1) If the first user has set a sharing-target medical image control method so that a counterparty, that is, the second user of the second viewer 120 cannot adjust and edit the sharing-target medical image, only an operation input by the first user of the first viewer 120 can influence the sharing-target medical image displayed on the second viewer 130, and the second user of the second viewer 130 cannot perform any operation on the sharing-target medical image. For example, as illustrated in FIG. 3, when the first user of the first viewer 120 performs an operation of rotating a sharing-target medical image, information about the rotation-related user operation is provided to the medical image sharing server 110, and the medical image sharing server 110 generates a rotated sharing-target medical image, that is, a second sharing-target medical image, by processing the rotation of the sharing-target medical image, that is, a first sharing-target medical image, and provides the generated second sharing-target medical image to the first and second viewers 120 and 130, thereby enabling the rotated sharing-target medical image to be shared between the first and second viewers 120 and 130.

(2) If the first user has set a sharing-target medical image control method so that a counterparty, that is, the second user of the second viewer 130 can freely adjust (the field of view, angle, zoom-in and zoom-out of) a sharing-target medical image, an operation input by the first user of the first viewer 120 can influence the sharing-target medical image displayed on the second viewer 130, and an operation input by the second user of the second viewer 130 can influence the sharing-target medical image displayed on the first viewer 120. For example, as illustrated in FIG. 4, when the first user of the first viewer 120 performs an operation of rotating a sharing-target medical image, information about the rotation-related user operation “a” is provided to the medical image sharing server 110, the medical image sharing server 110 may generate a rotated sharing-target medical image, that is, a second sharing-target medical image, by processing the rotation of the sharing-target medical image, that is, a first sharing-target medical image, and may provide the generated second sharing-target medical image “b” to the first and second viewers 120 and 130, thereby enabling the rotated sharing-target medical image to be shared between the first and second viewers 120 and 130. In the same manner, when the second user of the second viewer 130 performs an operation of expanding a sharing-target medical image, information about the expansion-related user operation “c” is provided to the medical image sharing server 110, the medical image sharing server 110 may generate an expanded sharing-target medical image by processing the expansion of a currently shared sharing-target medical image, and may provide the expanded sharing-target medical image “d” to the first and second viewers 120 and 130, thereby enabling the expanded sharing-target medical image to be shared between the first and second viewers 120 and 130.

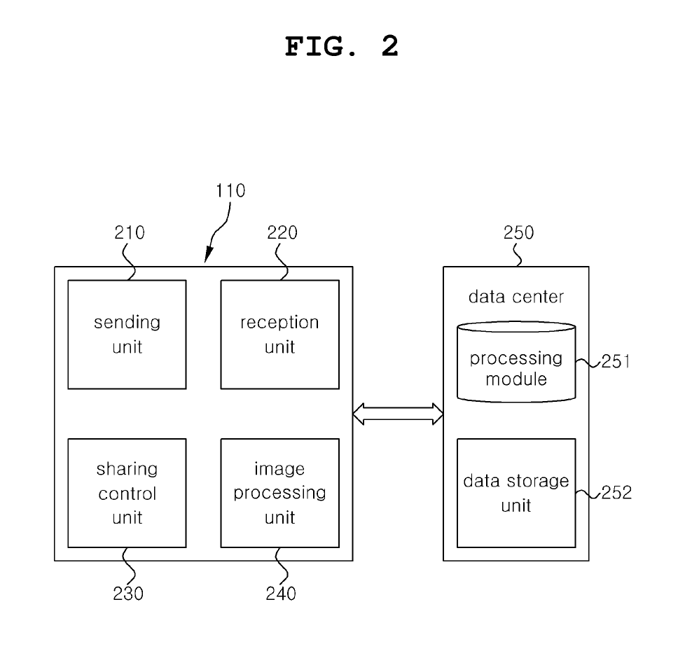

FIG. 2 is a diagram illustrating the configuration of the medical image sharing server illustrated in FIG. 1 according to an embodiment of the present invention.

Referring to FIG. 2, the medical image sharing server 110 includes a sending unit 210, a reception unit 220, a sharing control unit 230, and a image processing unit 240, and may further include a data center 250 in some situations.

The sending unit 210 provides a first medical image requested by the first user of the first viewer to the first viewer. The sending unit 210 may be configured to be under control of a processor sub-module (not shown) included in the server 110.

In this case, the sending unit 210 may provide information about a plurality of users to the first viewer in order to enable the second user to be selected.

As an example, the sending unit 210 may check the previously stored characteristic information of the first medical image requested by the first viewer, may search for a plurality of users corresponding to the characteristic information of the first medical image from among previously stored users, and may provide information about the plurality of retrieved users to the first viewer.

In this case, the characteristic information of the medical image may include the type of medical imaging apparatus that has captured the medical image, for example, a CT scanner, a MRI scanner, a PET scanner or an X-ray machine, a captured bodily region, a region of interest in the sharing-target medical image, a field related to the sharing-target medical image, etc.

As another example, the sending unit 210 may search for a plurality of users corresponding to information about the first user of the first viewer from among previously stored users based on the information about the first user, and may provide information about the plurality of users to the first viewer.

In this case, the information about the first user may include the department, professional field (for example, specialized cancer treatment) and/or the like of the first user, and may also include all user information that can be applied in connection with a collaborative diagnosis. Furthermore, the information about the first user may further include history information indicating that the first user has selected users in order to make collaborative diagnoses. The history information may include the characteristic information of sharing-target medical images, information about the selected users, and collaborative diagnoses-related information.

As another example, the sending unit 210 may provide information about a corresponding group requested by the first user and selected from among information about a plurality of user groups including a plurality of users to the first viewer.

In this case, the request from the first user may be received via a user interface provided in the first viewer or messenger.

In this case, the information about a user group may be classified according to its professional field (a medical department), in which case the information about a user group includes users in a corresponding field. Furthermore, the information about a user group may include information about a basic group set by the first user.

As described above, the sending unit 210 may search for a plurality of users corresponding to a specific criterion from among previously stored users, and may provide information about the plurality of retrieved users to the first viewer. The information about the users stored in the medical image sharing server 110 may be updated at regular time intervals. The information about the retrieved users provided to the first viewer 120 may include information about the priorities of users in each related field.

The reception unit 220 receives information about a second user who will make a collaborative diagnosis while sharing the first medical image with the first viewer. The reception unit 220 may be configured to be under control of the processor sub-module (not shown) included in the server 110.

In this case, the reception unit 220 may receive the information about a second user from the first viewer or from the second viewer. The reception unit 220 may receive the information about a second user when the first and second viewers are synchronized with each other via the messengers provided in the respective viewers.

The information about a second user received by the reception unit 220 refers to information about a user who is selected by the first user from among the plurality of users that are provided by the sending unit 210 to the first viewer.

Furthermore, the reception unit 220 may receive information about the sharing of the first medical image set by the first user of the first viewer. The information about the sharing of the first medical image may include information about first medical image-related information that is allowed to be provided to the second user and information about the allowed operations of the second user.

The reception unit 220 may receive an annotation, text, voice, etc. input by any one of the first and second users in the state in which the first medical image has been shared between the two viewers, and may provide the received information to the viewer of the other user via the sharing control unit 230.

The sharing control unit 230 controls the sending unit 210 to provide the first medical image to the second viewer of the second user based on the information about the second user received from the reception unit 220. That is, the sharing control unit 230 enables the medical image to be shared between the first and second viewers that make a collaborative diagnosis. The sharing control unit 230 may be configured to be a functional sub-module of the processor (not shown) included in the server 110.

Furthermore, the sharing control unit 230 may provide information about the sharing of the first medical image set by the first user to the second viewer along with the first medical image.

Furthermore, the sharing control unit 230 may provide annotation, text, and/or voice information received by the reception unit 220 to the viewers, thereby enabling the annotation, text, and/or voice information to be shared. Furthermore, the sharing control unit 230 may provide a second medical image generated by the image processing unit 240 in response to the user input of the first or second viewer to the first and second viewers, thereby enabling the second medical image to be shared. The image processing unit 240 may be configured to be a functional sub-module of the processor (not shown) included in the server 110.

When user input related to the manipulation of the first medical image is received from any one of the first and second viewers, the image processing unit 240 may process the first medical image based on the received user input, may generate a second medical image related to the first medical image, and may provide the second medical image to the first and second viewers via the sharing control unit 230.

In this case, the processing of the medical image performed by the image processing unit 240 may include operations, such as rotation, expansion, and reduction, may include an operation of overlaying an annotation on a screen, and may include 3D rendering, a region of interest (ROI) such as a tumor, segmentation related to the ROI or, CAD results.

The data center 250 includes a processing module 251 and a data storage unit 252, and may be viewed as an element that is used to centralize data therein in order to construct a thin-client environment. The data center 250 may be configured to be included in the medical image sharing server 110, and may be implemented as a separate means.

The data storage unit 252 is a means that stores all information related to the present invention, for example, a medical image, user information, and medical image-related information.

The processing module 251 may include an image processing module for processing rendering and the like, and may process a sharing-target medical image in response to a request from the image processing unit 240. It will be apparent that the processing module 251 may be configured to be included in the image processing unit 240.

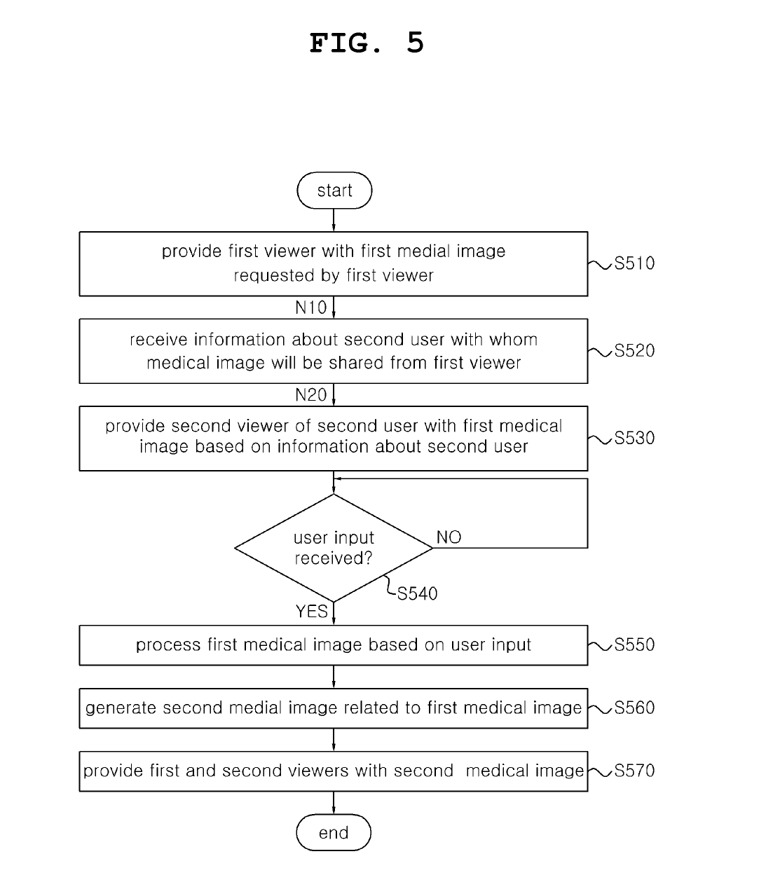

FIG. 5 is a flowchart illustrating the process of a server-based medical image sharing method according to an embodiment of the present invention. That is, FIG. 5 illustrates the operation of the medical image sharing server illustrated in FIG. 1.

Referring to FIG. 5, in the server-based medical image sharing method according to the present invention, a sharing-target medical image (first medical image), the sharing of which is requested by the first viewer, is searched for and is provided to the first viewer at step S510.

Once the first medical image has been provided to the first viewer and a second user along with whom a collaborative diagnosis will be made has been selected by the first user of the first viewer, information about the second user is received from the first or second viewer at step S520.

In this case, at step S520, the information about a second user may be received when synchronization is achieved via the messengers provided in the first and second viewers, or the information about a second user may be received at the time at which the second user is selected by the first user.

Furthermore, at step S520, not only the information about the second user but also information about the sharing of the first medical image set by the first user may be received.

Once the information about the second user has been received at step S520, the first medical image is provided to the second viewer of the second user based on the received information about a second user at step S530.

In this case, the medical image sharing server may provide information about a link to the first medical image to the second viewer, and the first medical image may be provided to the second viewer based on the information about a link. The information about a link may be provided directly from the medical image sharing server to the second viewer, and may be provided from the first viewer to the second viewer via the messengers. Then the second viewer may access the first medical image via the shared link. Depending on one of example of the invention, the second viewer may access the first medical image only via the shared link. In this case, the access permission of second viewer to the first medical image may be partially limited by the medical image sharing server.

Furthermore, at step S530, the information about the sharing of the first medical image received from the first viewer may be provided to the second viewer along with the first medical image.

Once the first medical image has been shared between the first and second viewers, it is determined whether user input is received from the first user of the first viewer or the second user of the second viewer at step S540.

In this case, at step S540, if it is determined based on the information about sharing set by the first user of the first viewer that the information about the sharing of the first medical image has been set such that the second user cannot perform an operation and/or editing, second user input may be disregarded even when the second user input is received.

When a user input is received from user any one viewer, the first medical image is processed based on the received user input at step S550, and then a second medical image related to the first medical image is generated at step S560.

In this case, step S550 may include both the case where the information about the sharing of the first medical image allows an operation and/or editing to be performed by the second user and the case where the information about the sharing of the first medical image does not allow an operation and/or editing to be performed by the second user. The second medical image may refer to a medical image that is generated by applying rotation, expansion, reduction, rendering, the addition of an annotation, and/or the addition of CAD results to the first medical image based on user input.

Once the second medical image has been generated, the generated second medical image is provided to the first and second viewer at step S570.

Although not illustrated in the drawings, when an annotation, text, voice and/or the like are received from any one viewer in a state in which the first medical image has been shared between the two viewers, the received annotation, text, voice and/or the like to the other viewer, thereby enabling them to be shared.

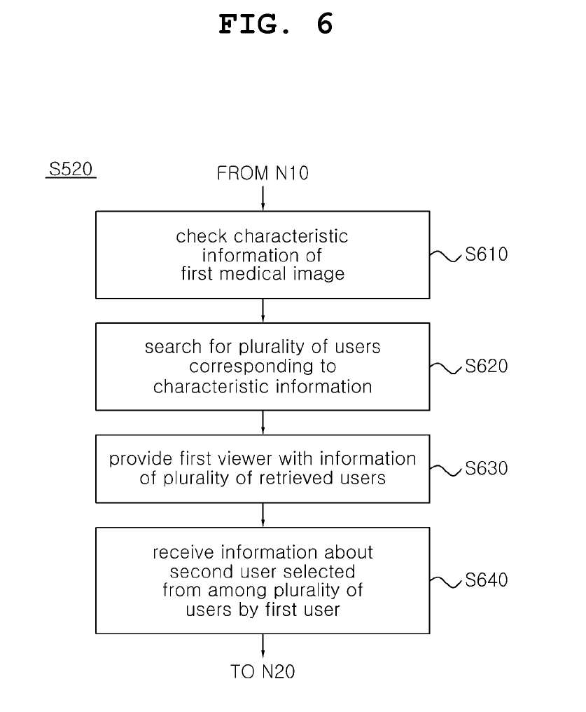

FIG. 6 is a flowchart illustrating the detailed process of step S520 illustrated in FIG. 5 according to an embodiment of the present invention.

Referring to FIG. 6, in step S520 of receiving information about the second user, the characteristic information of the first medical image requested by the first viewer is checked at step S610, and a plurality of users corresponding to the characteristic information of the first medical image are searched for from among previously stored users at step S620.

In this case, the characteristic information of the medical image may include the type of medical imaging apparatus that has captured the medical image, for example, a CT scanner, a MRI scanner, a PET scanner or an X-ray machine, a captured bodily region, a region of interest in the sharing-target medical image, a field related to the sharing-target medical image, etc.

Once the plurality of users has been retrieved, information about the plurality of retrieved users is provided to the first viewer at step S630, and, when a second user is selected from among the plurality of users by the first user of the first viewer, information about the selected second user is received at step S640.

Although the information about the second user may be received from the first viewer, the present invention is not necessarily limited thereto.

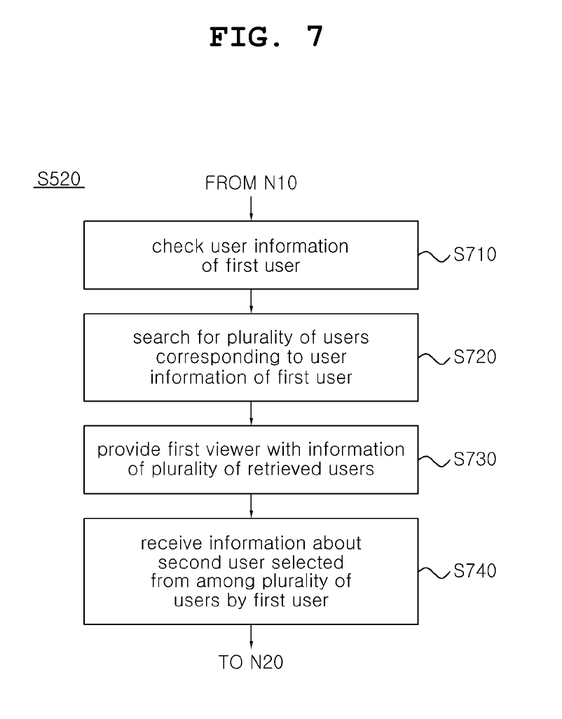

FIG. 7 is a flowchart illustrating the detailed process of step S520 illustrated in FIG. 5 according to another embodiment of the present invention.

Referring to FIG. 7, in step S520 of receiving information about the second user, information about the first user who has requested the first medical image is checked at step S710, and a plurality of users corresponding to the information about the first user are searched for from among previously stored users at step S720.

In this case, the information about the first user may include the department, professional field (for example, specialized cancer treatment) and/or the like of the first user, may further include history information indicating that the first user has selected users in order to make collaborative diagnoses, and may further include all user information that can be applied in connection with a collaborative diagnosis. The history information may include the characteristic information of sharing-target medical images, information about the selected users, and collaborative diagnoses-related information.

Once the plurality of users has been retrieved, information about the plurality of retrieved users is provided to the first viewer at step S730, and, when the second user is selected from among the plurality of users by the first user of the first viewer, information about the selected second user is received at step S740.

Furthermore, although not illustrated in the drawings, in step S520 of receiving information about the second user, information about a group corresponding to a request from the first user may be selected from previously stored information about a plurality of groups, the selected information about a group may be provided to the first viewer, and information about a second user selected by the first user from among a plurality of users included in the information about a group may be received from the first viewer.

In this case, the request from the first user may be received from the first viewer by the selection of the first user using the first viewer or the user interface provided in the messenger.

The server-based medical image sharing method according to the embodiment of the present invention may be implemented in the form of program instructions that are executable by various types of computer means, and may be recorded in a computer-readable storage medium. The computer-readable storage medium may include program instructions, data files, and data structures either independently or in combination. The program instructions stored in the medium may be designed and configured especially for the present invention or may be known to and usable by those skilled in the art of computer software. Examples of the computer-readable storage medium may include a magnetic medium, such as a hard disk, a floppy disk, or magnetic tape, an optical medium, such as CD-ROM or a DVD, a magneto-optical medium, such as a floptical disk, and a hardware apparatus, such as ROM, RAM, or flash memory which is especially configured to store and execute the program instructions. Examples of the program instructions include not only such machine language code that is created by a compiler, but also such high-level language code that is executable by a computer using an interpreter or the like. The hardware apparatus can be configured to function as one or more software modules so as to perform the operation of the present invention, and vice versa.

The remote collaborative diagnosis method and system using a server-based medical image sharing scheme according to the present invention have the advantages of sharing medical images between the viewers using information about links to the medical images via the server for providing medical images, facilitating remote collaborative diagnoses through the sharing of the medical images, and sharing medical images through the transmission and reception of information about links corresponding to the medical images via the messengers, thereby reducing data traffic between viewers and improving the security of medical images.

More specifically, the remote collaborative diagnosis method and system using a server-based medical image sharing scheme according to the present invention have the advantages of transmitting only information about a link to a medical image to be shared to the viewers of users who make a collaborative diagnosis via messengers, and receiving the sharing-target medical image corresponding to the information about a link from the medical image sharing server for providing medical images, thereby reducing traffic between viewers, and improving the security of medical images and protecting private information.

Furthermore, the present invention has the advantages of constructing an interface for sharing medical images in the messenger and enabling users with whom medical images will be shared to be easily selected via the interface, thereby facilitating the sharing of medical images and the making of remote collaborative diagnoses.

Moreover, the present invention has the advantage of enabling a plurality of users participating in a collaborative diagnosis in a remote environment to conveniently share the operation, such as expansion, reduction and the changing of direction, of a medical image displayed to the users in common, annotation, the selection of a medical image of interest from a set of various medical images, switching between a plurality of medical images displayed at the same time, 3D rendering, the results of additional processing, such as a computer aided diagnosis (CAD), and/or the like.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A server-based medical image sharing method, comprising:
providing, by a processor, a first viewer with a first medical image requested by a first user of the first viewer;
receiving, at the processor, information about a second user for sharing the first medical image with the first viewer;
providing, by the processor, a second viewer of the second user with the first medical image based on the information about the second user;
receiving, at the processor, a user input related to an operation of the first medical image from any one of the first and second viewers;
processing, by the processor, the first medical image based on the received user input, and generating a second medical image related to the first medical image; and
providing, by the processor, the first and second viewers with the generated second medical image.

2. The server-based medical image sharing method of claim 1, wherein the receiving information about the second user further includes, if the first and second viewers have been synchronized with each other, receiving the information about the second user from any one of the first and second viewers.

3. The server-based medical image sharing method of claim 2, wherein the first and second viewers are synchronized via messengers provided in the first and second viewers, respectively.

4. The server-based medical image sharing method of claim 1, further comprising receiving, at the processor, information about sharing set by the first user, which belongs to information related to the first medical image, from the first viewer;
wherein the providing the first medical image further includes providing the second viewer with the first medical image and the set information about sharing.

5. The server-based medical image sharing method of claim 1, further comprising, if at least one of an annotation, text, and voice information is received from any one of the first and second viewers, providing, by the processor, the other viewer with the received information so that the received information can be shared with the other viewer.

6. The server-based medical image sharing method of claim 1, wherein:
the providing the first medical image further includes searching for information about a user group requested by the first user from information about one or more user groups, and providing the first viewer with the retrieved information about the user group; and
the receiving the information about the second user further includes receiving information about the second user selected by the first user from among a plurality of users included in the retrieved information about the user group.

7. The server-based medical image sharing method of claim 1, wherein:
the providing the first medical image further includes searching for a plurality of users with whom the first medical image will be shared based on user information previously stored by the first user, and providing the first viewer with information of the plurality of retrieved users along with the first medical image; and
the receiving the information about the second user further includes receiving information about the second user selected by the first user from among the plurality of users.

8. The server-based medical image sharing method of claim 1, wherein the providing the first medical image further includes providing the second viewer with information about a link to the first medical image, and providing the second viewer with the first medical image via the link to the first medical image.

9. A non-transitory computer-readable medium containing executable program instructions executed by a processor that stores a program for executing a server-based medical image sharing method, comprising:
program instructions that provide a first viewer with a first medical image requested by a first user of the first viewer;
program instructions that receive information about a second user with whom the first medical image will be shared by the first viewer;
program instructions that provide a second viewer of the second user with the first medical image based on the information about the second user;
program instructions that receive a user input related to an operation of the first medical image from any one of the first and second viewers;
program instructions that process the first medical image based on the received user input, and generating a second medical image related to the first medical image; and
program instructions that provide the first and second viewers with the generated second medical image.

10. A server-based medical image sharing system, comprising:
a processor configured to:
provide a first user of a first viewer with a first medical image requested by the first user of the first viewer;
receive information about a second user with whom the first medical image will be shared by the first viewer;
provide a second viewer of the second user with the first medical image based on the information about the second user; and
when a user input related to an operation of the first medical image is received from any one of the first and second viewers, process the first medical image based on the received user input and generate a second medical image related to the first medical image;
wherein the processor is further configured to provide the first and second viewers with the generated second medical image.

11. The server-based medical image sharing system of claim 10, wherein the processor is further configured to:
if the first and second viewers have been synchronized with each other, receive the information about the second user from any one of the first and second viewers.

12. The server-based medical image sharing system of claim 11, wherein the first and second viewers are synchronized via messengers provided in the first and second viewers, respectively.

13. The server-based medical image sharing system of claim 10, wherein the processor is further configured to:
receive information about sharing set by the first user, which belongs to information related to the first medical image, from the first viewer; and
provide the second viewer with the first medical image and the set information about sharing.

14. The server-based medical image sharing system of claim 10, wherein the processor is further configured to:
if the processor receives at least one of an annotation, text, and voice information from any one of the first and second viewers, provide the other viewer with the received information so that the received information can be shared with the other viewer.

15. The server-based medical image sharing system of claim 10, wherein the processor is further configured to:
search for information about a user group requested by the first user from information about one or more user groups;
provide the first viewer with the retrieved information about the user group; and
receive information about the second user selected by the first user from among a plurality of users included in the retrieved information about the user group.

16. The server-based medical image sharing system of claim 10, wherein the processor is further configured to:
search for a plurality of users with whom the first medical image will be shared based on user information previously stored by the first user;
provide the first viewer with information about the plurality of retrieved users along with the first medical image; and
receive information about the second user selected by the first user from among the plurality of users.
